(19) United States
(12) Patent Application Publication
(10) Pub. No.: US 2008/0103765 A1
(43) Pub. Date: May 1, 2008

(54) Encoder Delay Adjustment

(75) Inventors: Ari Lakaniemi, Helsinki (FI); Olli Kirla, Espoo (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/555,370

(22) Filed: Nov. 1, 2006

(51) Int. Cl. G10L 19/12

(52) U.S. Cl. 704/222

(57) ABSTRACT

The present invention provides methods and apparatus for adjusting an algorithmic time delay of a signal encoder. An input signal is sampled at a predetermined sampling rate. When look-ahead operation is initiated, the algorithmic time delay is increased by the look-ahead time duration. When look-ahead operation is terminated, the algorithmic time delay is decreased by the look-ahead time duration. A set of input signal samples is aligned in accordance with the algorithmic time delay, and an output signal that is representative of the set of signal samples is formed. A first signal segment is added to an input signal waveform when the look-ahead operation is initiated, and a second signal segment is removed from the input signal waveform when the look-ahead operation is terminated. Pointers that point to a beginning of the current frame and to new input signal samples are adjusted when the operational mode changes.

### FIELD OF THE INVENTION

The present invention relates to adjusting an algorithmic time delay for a signal encoder, which may function in a speech codec.

### BACKGROUND OF THE INVENTION

End-to-end time delay often affects the overall quality service of a communication system. For example, with speech communications, the time delay should be short enough to allow natural conversation. While target one-way delay is recommended to be less than 150 ms, generally it has been assumed that one-way delays up to 200 ms can be expected to provide high level of interactivity causing no degradation to the subjective quality. With certain assumptions delays up to 400 ms are considered acceptable. However, although pushing one-way delays clearly below 200 ms cannot be expected to provide a substantial improvement in subjective quality of service, many communications systems are designed and thus operating in the delay range 200 to 400 ms. Furthermore, packet switched networks, e.g., IP based networks, are operating in a best-effort manner, and therefore the delays during peak load can even exceed 400 ms. Thus, even small time delay reductions can significantly contribute in minimizing the overall delay of a communications system to provide an improved user-experience.

### BRIEF SUMMARY OF THE INVENTION

An aspect of the present invention provides methods and apparatus for adjusting an algorithmic time delay of a signal encoder. An input signal, e.g., a speech signal, is sampled at a predetermined sampling rate. A processing module processes a segment of input signal consisting of a current frame and a segment of future signal, typically referred as a look-ahead segment. When look-ahead operation is initiated, the algorithmic time delay is increased by the look-ahead time duration. When look-ahead operation is terminated, the algorithmic time delay is decreased by the look-ahead time duration. A set of input signal samples is aligned in accordance with the algorithmic time delay, and an output signal that is representative of the set of signal samples is formed.

With another aspect of the invention, a first signal segment is added to an input signal waveform when the look-ahead operation is initiated, and a second signal segment is removed from the input signal waveform when the look-ahead operation is terminated.

With another aspect of the invention, a first pointer is equal to a second pointer when the look-ahead operation is terminated. The first pointer points to a beginning of the current frame and the second pointer points to new input signal samples. When the look-ahead operation is initiated, the first pointer is offset from the second pointer by the look-head time duration.

With another aspect of the invention, input signal samples are smoothed around a point of discontinuity when the operational mode changes.

### BRIEF DESCRIPTION OF THE DRAWINGS

A more complete understanding of the present invention and the advantages thereof may be acquired by referring to the following description in consideration of the accompanying drawings, in which like reference numbers indicate like features and wherein:

FIG. 1 shows a buffering structure of an input signal for a signal encoder that is configured for a look-ahead operation in accordance with an embodiment of the invention;

FIG. 2 shows a buffering structure of an input signal for a signal encoder that is configured for a look-ahead free operation in accordance with an embodiment of the invention;

FIG. 3 shows a flow diagram for a signal encoder controlling an algorithmic time delay in accordance with an embodiment of the invention;

FIG. 4 shows an architecture of a signal encoder that controls an algorithmic time delay in accordance with an embodiment of the invention; and

FIG. 5 shows an architecture of a wireless system that incorporates a codec in accordance with the invention.

### DETAILED DESCRIPTION OF THE INVENTION

In the following description of the various embodiments, reference is made to the accompanying drawings which form a part hereof, and in which is shown by way of illustration various embodiments in which the invention may be practiced. It is to be understood that other embodiments may be utilized and structural and functional modifications may be made without departing from the scope of the present invention.

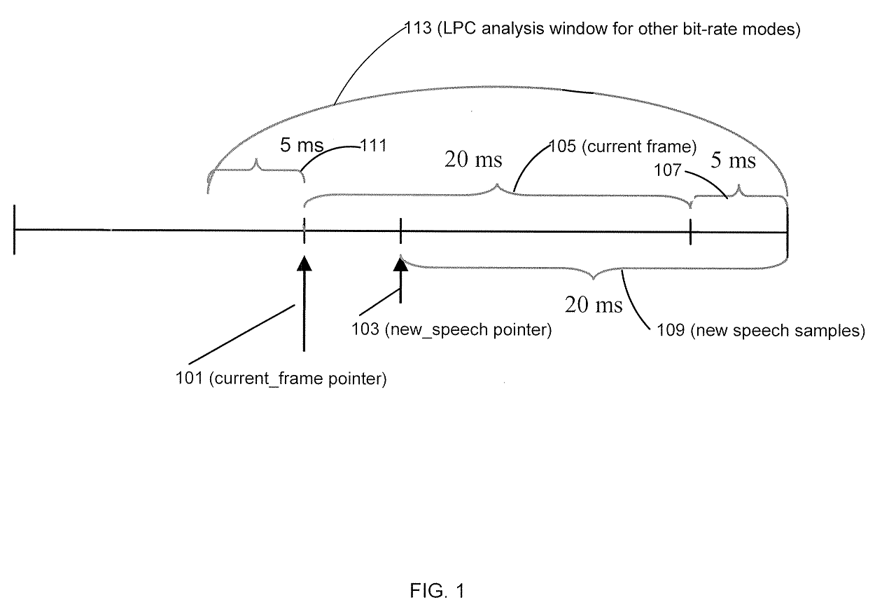

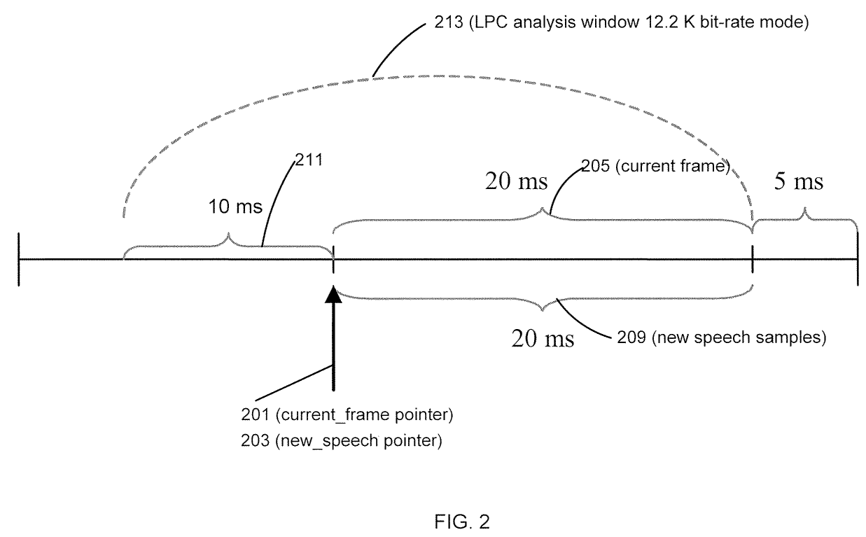

FIG. 1 shows a buffering structure of an input signal for a signal encoder that is configured for a look-ahead operation in accordance with an embodiment of the invention. With an embodiment of the invention, the signal encoder utilizes an adaptive multi-rate (AMR) speech algorithm. For example, the AMR speech coder (in accordance with 3GPP TS 26.290) supports a plurality of bit-rates including bit-rate modes of 12.2 kbits/sec, 10.2 kbits/sec, 7.95 kbits/sec, 7.40 kbits/sec, 6.70 kbits/sec, 5.90 kbits/sec, 5.15 kbits/sec, and 4.75 kbits/sec. FIG. 1 shows a buffering structure in which the bit-rate is not equal to 12.2 kbits/sec. FIG. 2, as will be discussed, shows a buffering structure in which the bit-rate equals 12.2 kbits/sec for the AMR speech coder. (The standard AMR encoder uses the buffering structure according to FIG. 1 in the 12.2 kbits/sec mode. While the 5 msec look-ahead segment is provided in the 12.2 kbits/sec mode, the standard AMR encoder does not utilize the look-ahead segment in this mode.)

An adaptive multi-rate algorithm is the default speech codec that is used for the narrowband telephony service in 3^{rd} generation 3GPP networks. (The term CODEC denotes CODer-DECoder or the encoder-decoder combination. The adaptive multi-rate algorithm is also the third codec option for GSM and an optional codec for VoIP using RTP.) The algorithm has different algorithmic delay requirements between different configurations. Look-ahead operation is typically used for the LPC analysis to provide smoother transition of the signal spectrum from frame to frame, and partially also for the Voice Activity Detection (VAD) algorithm. However, the highest bit-rate mode (12.2 kbits/sec) does not use the look-ahead. The standard version of the AMR encoder (as used in 3^{rd} generation 3GPP networks) also imposes look-ahead for the 12.2 kbits/sec mode, which enables fast adaptation between the 12.2 kbits/sec mode and the other AMR modes employing the look-ahead. However, in certain applications, the set of active modes may be limited only to 12.2 kbits/sec mode, which would make the 5 ms look-ahead unnecessary delay component. Such services may be the 3G circuit switched telephony, voice over IP (VoIP), and unlicensed mobile access (UMA). All these services have typically high enough bandwidth to provide the highest quality AMR mode for all voice traffic. Embodiments of the inventions, as shown in FIGS. 1-2, enable circumventing the need for look-ahead operation to be imposed for the 12.2 kbits/sec mode.

Referring to FIG. 1, each incoming new_speech segment 109 of input speech (having a time duration of 20 msec) is stored to the location pointed by new_speech pointer 103. Encoding is performed on current frame 105 that starts at a time corresponding to current_frame pointer 101 and has a time duration of 20 msec. Thus, only the first 15 ms of new_speech segment 109 is encoded in current frame 105, and the last portion 107 (having a time duration of 5 ms) of new_speech segment 109 provides a look-ahead, which will be the first 5 ms of the next frame (not shown). Buffer 111 subsequent (to the left of) to current_frame 105 contains speech samples from the previous frame (not shown) and spans a time duration of 5 msec. Subsequent buffer 111 is included for linear predictive coefficient (LPC) analysis during LPC analysis window 113 (having a time duration of 30 msec). LPC analysis window 113 subsequent buffer 111, current frame and last portion 107.

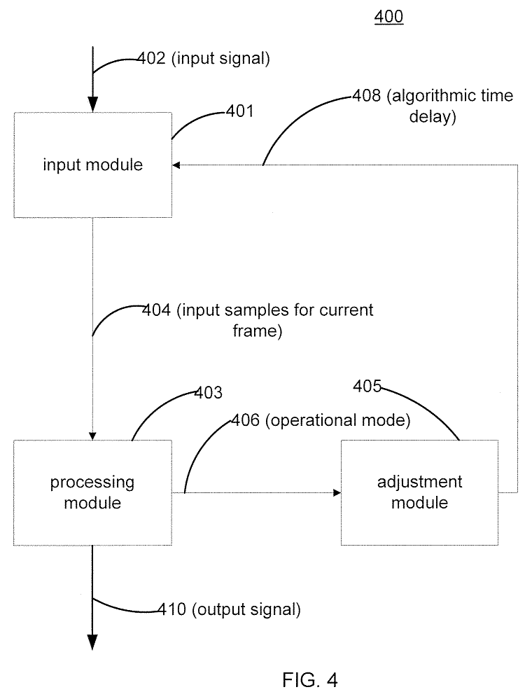

In accordance with embodiments of the invention, the speech encoder 400 (as shown in FIG. 4) models a speech input by a plurality of parameters (based on a model for generating a speech signal) and transmits information indicative of the plurality of parameters during current frame 105. Such encoders are often referred as vocoders. For example, a channel vocoder uses a bank of filters or digital signal processors to divide the signal into several sub-bands. After rectification, the signal envelope is detected with bandpass filters, sampled, and transmitted. (The power levels may be transmitted together with a signal that represents a model of the vocal tract.) Reception is basically the same process but in reverse. This type of vocoder typically operates between 1 and 2 kbits/sec. Even though these coders are efficient, these coders produce a synthetic quality and therefore are not generally used in commercial systems. Since speech signal information is primarily contained in the formants, a vocoder that can predict the position and bandwidths of the formants can achieve high quality at very low bit rates. A formant vocoder transmits the location and amplitude of the spectral peaks instead of the entire spectrum. These coders typically operate in the range of 1000 bit/sec. Formant vocoders are not typically used because the formants are difficult to predict. Another class of vocoder is a linear predictive encoder, which is widely used in current technology, e.g., digital Personal Communications Services (PCS). The LPC algorithm (linear predictive coefficient) assumes that each speech sample is a linear combination of previous samples. Speech is sampled, stored and analyzed. Coefficients, which are calculated from the sample are transmitted and processed in the receiver. With long term correlation from samples, the receiver accurately processes and categorizes voiced and unvoiced sounds. The LPC family uses pulses from an excitation pulse generator to drive filters whose coefficients are set to match the speech samples. The excitation pulse generator differentiates the various types of LP coders. LP filters are fairly easy to implement and simulate filtering and acoustic pulses produced in the mouth and throat. Another class of vocoder is a regular pulse excited (RPE) vocoder. A RPE vocoder analyses the signal waveform to determine if the signal waveform is voiced or unvoiced. After determining the period for voiced sounds, the periodicity is encoded and the coefficient is transmitted. When the signal changes from voiced to unvoiced, information is transmitted that stops the receiver from generating periodic pulses and starts generating random pulses to correspond to the noise-like nature of fricatives. Another class of vocoder is a code book excited (CELP) vocoder. A CELP vocoder is optimized by using a code book (look up table) to find the best match for the signal. Another class of vocoder is based on algebraic code excited linear prediction (ACELP) technology, which provides a basis for adaptive multi-rate (AMR) speech coding. Algebraic code excited linear prediction uses a limited set of distributed pulses that functions as the excitation to a linear prediction filter.

Another class of encoder typically uses Time Domain or Frequency Domain coding and attempts to reproduce the original signal (waveform) with assuming that the original signal is a speech signal. Consequently, a waveform encoder does not assume any previous knowledge about the signal. The decoder output waveform is very similar to the signal input to the coder. Examples of these general encoders include uniform binary coding for music compact disks and pulse code modulation for telecommunications. Pulse code modulation (PCM) encoder is a general encoder often used in standard voice grade circuits.

FIG. 2 shows a buffering structure of an input signal for a signal encoder that is configured for a look-ahead free operation in accordance with an embodiment of the invention. With an embodiment of the invention, the signal encoder comprises an adaptive multi-rate (AMR) speech coder, in which the bit-rate equals 12.2 kbits/sec. With look-ahead free operation, new_speech pointer 203 is set to the same time as current_frame pointer 201. Samples from new_speech segment 209 directly form current frame 205 without waiting for a look-ahead portion. Consequently, a one-way time delay is reduced by 5 msec relative to waiting for the look-ahead portion of speech. For example, note that e.g. in a MS-to-MS GSM call there are two AMR encoders in the end-to-end path (unless Transcoder Free Operation (TrFO) is used). Thus, the overall delay reduction in this case would be 10 ms (5 msec delay reduction at both encoders). LPC analysis window 213 has a 30 msec time duration spanning buffer 211 (with a time duration 10 msec) and current frame 205.

As shown in FIGS. 1 and 2, the algorithmic time delay may be altered during a session when the bit-rate changed between 12.2 kbits/sec (corresponding to the look-ahead free operation) to another bit rate (i.e., 10.2 kbits/sec, 7.95 kbits/sec, 7.40 kbits/sec, 6.70 kbits/sec, 5.90 kbits/sec, 5.15 kbits/sec, and 4.75 kbits/sec corresponding to the look-ahead operation) for the AMR encoder. (Note that, in accordance with an embodiment of the invention, the standard 3GPP AMR encoder is modified and may be referred as a modified AMR encoder.) However, embodiments of the invention support signal encoders in which algorithmic time delays change for more than two operational modes. For example, different bit-rates may utilize different look-ahead time durations.

Speech and audio codecs typically operate on fixed algorithmic delay. Consequently, the time delay associated with the coding algorithm remains constant. The time delay may be a constant value for a given codec or may be dependent on the employed configuration of the codec. An example of a codec with different configurations having different time delay requirements is the AMR-WB+ codec, in which the mono operation has algorithmic delay of approximately 114 ms, while stereo operation imposes an algorithmic delay of approximately 163 ms. However, once the codec/encoder is initialized to operate using certain configuration, the configuration typically cannot be changed without re-initializing the codec and starting a new session.

With the embodiment shown in FIGS. 1-2, the AMR encoder provides a delay reduction during a call (session) when the bit-rate equals 12.2 kbits/sec. Since the 12.2 kbits/sec mode does not employ the 5 ms look-ahead needed for the LPC analysis in other AMR modes, the (algorithmic) delay can be optimized by omitting the look-ahead when using the AMR codec in the 12.2 kbits/sec mode. Furthermore, since there is a possibility that the active mode-set may change during the call (session) from one containing only the 12.2 kbits/sec mode to one containing (also) other modes or vice versa, the AMR encoder supports mechanisms that can be used to switch look-ahead operation on or off during the call/session.

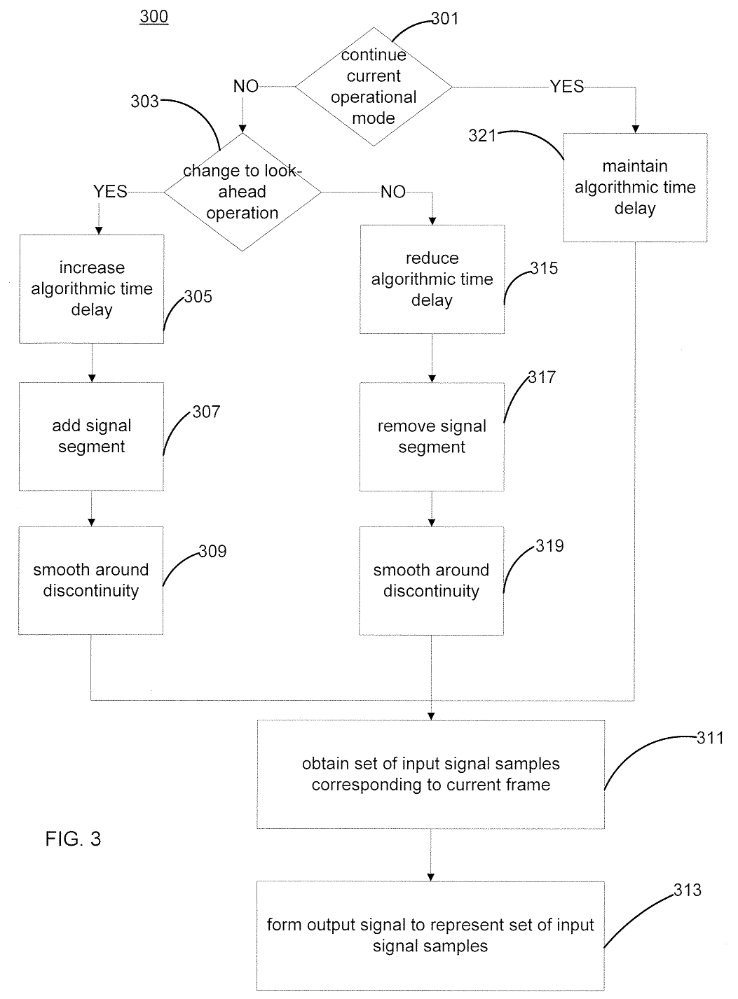

FIG. 3 shows flow diagram 300 for a signal encoder controlling an algorithmic time delay in accordance with an embodiment of the invention. Step 301 determines if the current operational mode should continue. For example, when the adaptive multi-rate speech coder changes between 12.2 kbits/sec and another bit-rate, the current operational mode changes. Otherwise, the current operational mode continues, and consequently step 321 is executed to maintain the current algorithmic time delay.

In step 303, process 300 determines whether the operational mode should change to look-ahead operation (corresponding to FIG. 1). If so, the algorithmic time delay is increased in step 305 and a signal segment is inserted into the signal waveform in step 307 to complete the signal segment during the increased algorithmic time delay.

An improvement for voice quality when switching between look-ahead operation and look-ahead-free operation (when look-ahead operation is initiated or look-ahead operation terminates) may be obtained by modifying the signal around the point of discontinuity, i.e., between the input signal from the previous frame and the new input signal, to ensure smooth transition. One way to perform this is to use “cross-fading.” (This approach is termed as the non-pitch-synchronous method.) Because the signal segment is added in step 307, the signal waveform may be smoothed (cross-faded) around the resulting point of discontinuity by step 309. With an embodiment of the invention, the generation of the first signal segment when initiating the look-ahead operation is determined by:

current_frame (k)=w1(k)*current_frame(k−40)+w2(k)*new_speech(k) (EQ. 1)

where 0<=k<40 and

current_frame (k+40)=new_speech(k) (EQ. 2)

where 0<=k<160 and

w1(k)=(k+1)/41 (EQ. 3)

and

w2(k)=1−w1(k) (EQ. 4)

From EQs. 1-4, the first signal segment (as determined in step 307) has a weighted sum of 5 ms pieces surrounding the inserted signal segment. In this case, the whole new input frame (indices from 0 to 159) is written into the buffer unmodified. EQs. 1-4 are exemplary for providing smoothing (as determined by step 309) around the point of discontinuity resulting from initiating look-ahead operation. For example different weighting functions w1 and w2 may be used. The above computation implies that, in addition to inserting a 5 ms segment of speech, the first 5 ms segment of the new input speech is also modified to provide a smoother change from the signal segment that precedes the inserted piece of signal. The remaining 15 ms portion of the new input frame is inserted into the buffer unmodified.

With smoothing according to EQs. 1-4 around the point of discontinuity, the energy of the signal waveform changes smoothly so that there are no sudden and potentially annoying disturbances being introduced. For non-speech and unvoiced signals this approach provides essentially seamless transition. However, voiced speech having periodic structure with a period length clearly different from a time duration of 40 sample points (corresponding to 5 msec with a predetermined sampling rate of 8000 samples per second) may result in quality degradation due to an irregularity in periodicity introduced by processing.

Referring to FIG. 3, if step 303 determines that the operational mode should change to look-ahead-free operation (corresponding to FIG. 2), the algorithmic time delay is reduced in step 315, and a signal segment is removed from the signal waveform in step 317 to complete the signal waveform during the algorithmic time delay decrease.

Similar to the above discussion, an improvement for voice quality when switching from look-ahead operation and look-ahead-free operation may be obtained by “cross-fading” the signal around the point of discontinuity, i.e., between the input signal from the previous frame and the new input signal. Because the signal segment is removed in step 317, the signal waveform may be smoothed (cross-faded) around the resulting point of discontinuity by step 319. When look-ahead operation is terminated, one can mix a portion of speech (having a 5 msec time duration corresponding to 40 samples of signal at 8 kHz sampling rate) that was used as a look-ahead for the previous frame (i.e. the signal segment between “current_frame” and “new_speech” as shown in FIG. 1) and the first 5 msec portion of the new input frame. With an embodiment of the invention, the removal of a signal segment when terminating the look-ahead operation is determined by:

current frame (k)=w2(k)*current_frame(k)+w1(k)*new_speech(k) (EQ. 5)

where 0<=k<40 and

current_frame (k)=new_speech(k) (EQ. 6)

where 40<=k<160 and

where w1(k)=(k+1)/41 (EQ. 7)

and

w2(k)=1−w1(k) (EQ. 8)

Note that with the above embodiment, the weighing factors w1 and w2 are the same when look-ahead operation is initiated or terminated (corresponding to EQs. 3, 4, 7, and 8).

In step 311, a set of samples from the signal waveform is obtained in response to processing by steps 305-309 and 315-319 that corresponds to current frame 105. In step 313, an output signal is generated to represent the set of samples. For example, with an embodiment of the invention, linear predictive coefficients are determined from the samples in conjunction with an assumed speech mode.

Embodiments of the invention support other approaches when switching between look-ahead operation and look-ahead-free operation, in which the algorithmic time delay is changed. With an embodiment of the invention, the signal encoder is reset and the speech pointers are re-initialized according to the desired mode of operation (as shown in FIGS. 1 and 2). When look-ahead operation is switched off (corresponding to look-ahead-free being initiated) during a call (session), the encoder internal memory is reset and the pointers to the input speech buffer are re-initialized to values as shown in FIG. 2 to provide look-ahead-free operation. When look-ahead operation is switched on (corresponding to look-ahead-free operation being terminated) during a call, the encoder reset is performed and the input speech pointers are set to values as shown in FIG. 2.

Note that after the encoder reset, one should also reset the decoder to insure decoder stability due to encoder-decoder resynchronization. This action can be performed by sending a homing frame to the decoder. This approach simplifies implementation, where only few lines of the encoder source code may be modified to provide look-ahead-free operation. However, reduced voice quality may occur during the change of mode of operation. A codec reset can be expected to completely mute the decoder output for a short while, and the normal operation is restored only after few processed frames. (The term CODEC denotes CODer-DECoder or the encoder-decoder combination.)

Embodiments of the invention may also utilize an approach in which the pointers are re-initialized without resetting the encoder when changing between look-ahead operation and look-ahead-free operation. When switching look-ahead operation off, this approach requires only resetting the pointer values from values shown in FIG. 1 to values shown in FIG. 2. For switching look-ahead operation on with this approach, one changes the values of the pointer and also generates an additional input speech segment by repeating the most recent 5 ms segment of input speech (i.e., the last 5 ms of the previous input frame) to fill the gap between the speech from the previous frame and the new input speech. While this approach does not require extensive alterations of the existing encoder and does not require resetting of the decoder, there may be reduced voice quality in certain cases. While this approach typically offers little degradation for non-speech signals and for unvoiced signals, voiced signals may be degraded from the discontinuity caused by speech buffer manipulation disrupting the periodic structure, often corresponding to a “click” in the decoded speech.

Embodiments of the invention also utilize an approach in which pitch-synchronous methods exploit the long-term periodicity of speech when switching between the look-ahead mode and the look-ahead-free mode. Consequently, when switching off look-ahead operation, waveform shortening is performed by removing pieces of signal that are integer multiples of the current (pitch) period length. When switching on look-ahead operation, this approach repeats the past signal in segments that are integer multiples of the current (pitch) period length. For example, when the current pitch period equals a time duration spanning p samples, waveform shortening (i.e., removing a segment equal to the look-ahead time duration) is determined by:

current_frame (40−p+k)=new_speech(k) (EQ. 9)

where 0<=k<160
Waveform extension (i.e., adding a segment equal to the look-ahead time duration), is determined by:

current_frame (k)=current_frame(k−p) (EQ. 10)

where 0<=k<p

current_frame (k+p)=new_speech(k) (EQ. 11)

where 0<=k<160

With the above approach, the amount of waveform shortening or extension is dependent on the current pitch period length, i.e., the processing is dependent on the current input signal characteristics. Therefore, in most cases, it is not possible to exactly match the desired change in signal length. Furthermore, when shortening the signal waveform, one can cut away at most 5 ms of signal in order to still provide a full 20 ms frame of signal for encoding. Thus, if the current pitch period is longer than 5 msec, one cannot perform pitch-synchronous shortening of signal. If the pitch is shorter than 5 msec, one can only remove part of the signal waveform spanning the look-ahead time duration. Similarly, when extending the signal waveform, one needs to insert at least 5 msec of an additional segment, which implies that, in case of a pitch shorter than 5 msec, one needs to repeat the pitch period as many times as it is required to have at least 5 msec of the first segment. Consequently, one may introduce a first segment that has a time duration that is longer than 5 msec.

Thus, although the pitch-synchronous approach provides good voice quality with respect to the approaches that are described above, one should be cognizant of the following considerations:
In most cases the look-ahead removal needs to be done in several steps, meaning that the completely removing the look-ahead will take several frames.
In most cases inserting the look-ahead means that one first introduces the delay by more than 5 msec, and the extra part (beyond 5 msec) is removed during the next frames (using the same mechanism as used for look-ahead removal).

Embodiments of the invention also support the combination of the pitch-synchronous approach with other approaches as described above. For example, in case of non-speech and unvoiced input speech, one can use the non-pitch-synchronous processing, while for voiced speech one uses pitch-synchronous processing. One can further tune processing by inserting a first segment using non-pitch-synchronous processing (since it most probably is time critical) and employing pitch-synchronous processing only for removing/shortening the signal waveform (since it can be assumed to be less time critical).

In the above exemplary embodiments that support an AMR codec as shown in FIGS. 1 and 2, the time delay is reduced without substantially compromising the basic functionality or voice quality. For example, when an encoder (in accordance with FIGS. 1-2) is incorporated both in a network and a terminal, a decrease of 10 ms in one-way delay will be achieved for MS-to-MS calls. In case a forced payload compression over the backbone of a core network, a decrease of up to 15 ms may be possible.

FIG. 4 shows an architecture of signal encoder 400 that controls an algorithmic time delay in accordance with an embodiment of the invention. Input signal 402 is sampled by input module 401 at a predetermined sample rate (e.g., 8000 samples per second). Input samples 404 are aligned for current frame 105 and current frame 205 (as shown in FIG. 1 and 2) and are processed by processing module 403. Processing module 403 determines the operational mode 406 (e.g., look-ahead or look-ahead-free). Consequently, adjustment module 405 adjusts algorithmic time delay 408 so that input module 401 can align input samples 404 in accordance with operational mode 406 (e.g., LPC analysis window 113 for look-ahead operation or LPC analysis window 213 for look-ahead-free operation).

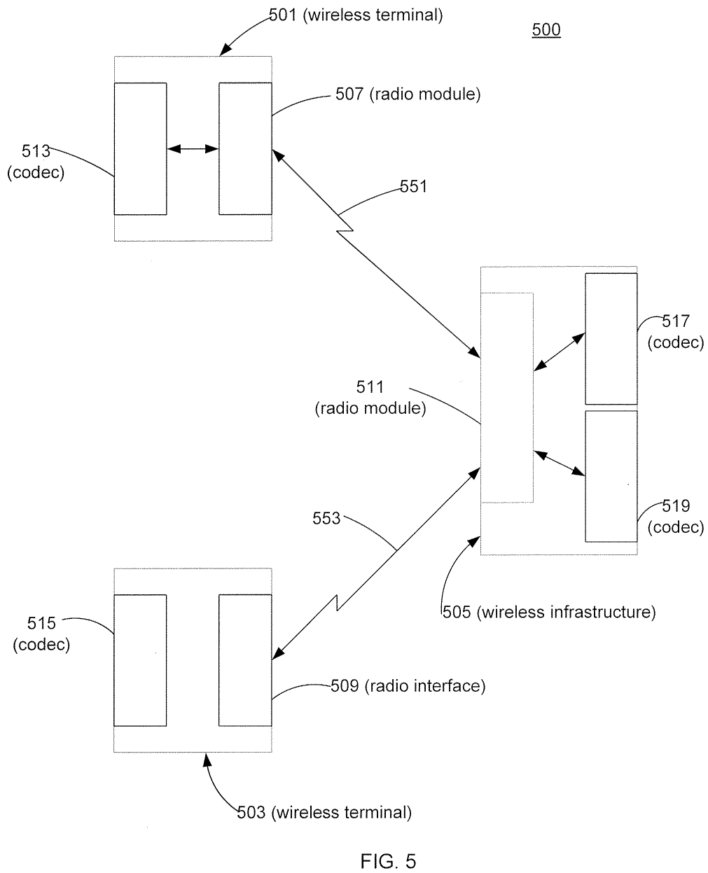

FIG. 5 shows an architecture of wireless system 500 that incorporates a codec in accordance with the invention. Embodiments of the invention may also support fixed networks (e.g., VoIP or VOATM). Wireless system 500 comprises wireless infrastructure 505, which may include at one base transceiver station (BTS) and base station controller (BSC). Wireless system 500 provides two-way wireless service for wireless terminals 501 and 503 over wireless channels 551 and 553, respectively. With an embodiment of the invention, wireless terminal 501 comprises radio module 507 and codec 513, which processes speech signals in accordance with FIGS. 1-4. Similarly, wireless terminal 503 comprises radio module 509 and codec 515. Two-way communications (from wireless terminal 501 to wireless infrastructure 505 and from wireless infrastructure 505 to wireless terminal 501) for wireless terminal 501 is established through codec 513, radio module 507, wireless channel 551, radio module 511, and codec 517. Two-way communications for wireless terminal 503 is established through codec 515, radio module 509, wireless channel 553, radio module 511, and codec 519.

As can be appreciated by one skilled in the art, a computer system with an associated computer-readable medium containing instructions for controlling the computer system can be utilized to implement the exemplary embodiments that are disclosed herein. The computer system may include at least one computer such as a microprocessor, digital signal processor, and associated peripheral electronic circuitry.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A method comprising:
(a) sampling, by a signal encoder, an input signal at a predetermined sampling rate to obtain a plurality of input signal samples;
(b) when a look-ahead operation is initiated by the signal encoder:
(b)(i) increasing an algorithmic time delay by a look-ahead time duration, wherein the signal encoder is operating in a first operational mode; and
(b)(ii) adding a first input signal segment to the plurality of said input signal samples;
(c) when the look-ahead operation is terminated by the signal encoder:
(c)(i) decreasing the algorithmic time delay by the look-ahead time duration, wherein the signal encoder is operating in a second operational mode; and
(c)(ii) discarding a second input signal segment from the plurality of said input signal samples;
(d) when the operational mode does not change, maintaining the algorithmic time delay;
(e) obtaining a set of said input signal samples from the plurality of said input signal samples in accordance with the algorithmic time delay; and
(f) forming, by the signal encoder, an output signal during a current frame, the output signal being representative of the set of said input signal samples.

2. The method of claim 1, wherein (c)(i) comprises:
(c)(i)(1) setting a first pointer to be equal to a second pointer, the first pointer pointing to a beginning of the current frame, the second pointer pointing to new input signal samples.

3. The method of claim 1, wherein (b)(i) comprises:
(b)(i)(1) offsetting a first pointer from a second pointer by the look-ahead time duration, the first pointer pointing to a beginning of the current frame, the second pointer pointing to new input signal samples.

4. The method of claim 1, wherein (b)(ii) comprises:
(b)(ii)(1) modifying said input signal samples around a point of discontinuity.

5. The method of claim 1, wherein (c)(ii) comprises:
(c)(ii)(1) modifying said input signal samples around a point of discontinuity.

6. The method of claim 1, wherein the input signal comprises a speech signal.

7. The method of claim 6, wherein (f) comprises:
(f)(i) determining at least one parameter that models the speech signal.

8. The method of claim 1, further comprising:
(g) resetting the signal encoder when the operational mode changes.

9. The method of claim 1, wherein (b)(ii) comprises:
(b)(ii)(1) repeating a most recent input signal segment.

10. The method of claim 1, wherein (b)(ii) comprises:
(b)(ii)(1) aligning the first input signal segment to a current pitch period length.

11. The method of claim 1, wherein (c)(ii) comprises:
(c)(ii)(1) aligning the second input signal segment to a current pitch period length.

12. A signal encoder comprising:
an input module sampling an input signal at a predetermined sampling rate to obtain a plurality of input signal samples;
a signal processing module processing a set of said input signal samples from the plurality of said input signal samples in accordance with an algorithmic time delay and forming an output signal that is representative of the set of said input signal samples; and
an adjustment module determining the algorithmic time delay adjustment that is applied by the signal processing module to obtain the set of said input signal samples from the plurality of said input signal samples, by:
initiating a look-ahead operation when the signal encoder is operating in a first operational mode; and
terminating the look-ahead operation when the signal encoder is operating in a second operational mode.

13. The signal encoder of claim 12, the signal processing module inserting a first input signal segment to the plurality of said input signal samples when the adjustment module initiates the look-ahead operation.

14. The signal encoder of claim 12, the signal processing module discarding a second input signal segment from the plurality of said input signal samples when the adjustment module terminates the look-ahead operation.

15. The signal encoder of claim 12, the signal processing module adjusting an input buffer pointer when changing the operational mode.

16. The signal encoder of claim 12, the signal processing module resetting the signal encoder when the operational mode changes.

17. The signal encoder of claim 12, the input module sampling the input signal having speech characteristics.

18. The signal encoder of claim 12, the signal processing module modifying said input signal samples around a point of discontinuity when the operational mode changes.

19. The signal encoder of claim 12, wherein the first operational mode corresponds to a first bit-rate and the second operational mode corresponds to a second bit-rate.

20. A computer-readable medium having computer-executable components comprising:
(a) sampling an input speech signal at a predetermined sampling rate to obtain a plurality of input speech samples;
(b) when a look-ahead operation is initiated:
(b)(i) increasing an algorithmic time delay of a speech encoder by a look-ahead time duration, wherein the speech encoder is operating in a first operational mode; and
(b)(ii) adding a first input speech segment to the plurality of said input speech samples;
(c) when the look-ahead operation is terminated:
(c)(i) decreasing the algorithmic time delay by the look-ahead time duration, wherein the speech encoder is operating in a second operational mode; and
(c)(ii) discarding a second input speech segment from the plurality of said input signal samples;
(d) when the operational mode does not change, maintaining the algorithmic time delay;
(e) obtaining a set of said input speech samples from the plurality of said input speech samples in accordance with the algorithmic time delay;
(f) determining at least one parameter that is representative of the set of said input speech samples; and
(f) inserting information indicative of the at least one parameter into a current transmitted frame.
